(19) United States
(12) Patent Application Publication
(10) Pub. No.: US 2003/0014386 A1
(43) Pub. Date: Jan. 16, 2003

(54) Account management module database interface

(76) Inventor: Anthony J. Jurado JR., Highland, MI (US)

Correspondence Address: HOGAN & HARTSON LLP, ONE TABOR CENTER, SUITE 1500, 1200 SEVENTEEN ST., DENVER, CO, 80202, US

(21) Appl. No.: 09/907,415

(22) Filed: Jul. 16, 2001

(51) Int. Cl. G06F 7/00

(52) U.S. Cl. 707/1

(57) ABSTRACT

The present invention provides a method for an account management module database interface for NIS servers. According to one embodiment, the present invention automatically generates key files used to build NIS database manager maps which control the access to systems on a local area network, which may be UNIX systems. According to another embodiment, this interface is divided into two components, viz.: the bulkload and the data pull. Both components access a relational database to update and pull data used to generate the data. According to another embodiment, the bulkload component is able to read the password, group and auto_home files, validate the record's contents, and update the database with information which meets a validation criteria. According to another embodiment, the data pull component can pull out the necessary data from the database so that files required to build the password, shadow, group, auto_home, and aliases map can be generated.

### BACKGROUND OF THE INVENTION

1. Field of the Invention

The present invention relates primarily to the field of servers in computer systems, and in particular to a method and apparatus for an account management module database interface for servers.

Portions of the disclosure of this patent document contains material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Many companies divide their workforce into sections based on their physical location within the company, and further into groups based on their job duties or some other hierarchy in which the company divides its employees. For example, a company such as a law firm may have partners, each of whom may have a group of people working under them. This group may include associate lawyers, paralegals, legal assistants, secretaries, and other support staff. A law firm may decide to divide its workforce into each partner and his/her team, or may decide to divide the workforce based on job duties where all lawyers form a first group, all paralegals form a second group, all legal assistants form a third group, all secretaries form a fourth group, while all other support staff form a fifth group.

In either case the discussions might be applied to a computer database system or a server. In this case, there is a system administrator assigned to each group, if each group is large enough to be managed by a single system administrator. In other cases there could be a single system administrator assigned to several groups, if the groups are very small in size. The system administrator regularly monitors and updates files and other activities of his/her group. If a company is spread across several buildings or even cities, then there could be one system administrator assigned to each section who regularly monitors and updates files and other activities of his/her section. If there are multiple administrators each controlling a section, then the server might be administered inconsistently. This can lead to problems. Before discussing this problem however, some background information of a specific type of server, called Naming Information System (IS) server is provided.

Naming Information System (NIS) Servers

NIS servers are one kind of servers that companies use to connect systems, especially UNIX based systems. A NIS server manages and controls UNIX accounts of all the employees it serves, and depending upon the size and geographical spread of the company there can be several such NIS servers to serve each group or section. A system administrator has jurisdiction over the NIS server under his/her control, and can administer the NIS server differently from the NIS servers under other system administrators.

Even though the company may have standardized set of rules and policies regarding the administration of all NIS servers, each system administrator may have certain unique and different policies regarding administering his/her NIS server from the others. For example, NIS servers used to pool data from various applications and machines for testing need to be updated more often then servers that are used to carry out the regular administrative work of the company.

This means that NIS servers are not consistent in the way they are administered, and this may lead to problems. Some of the more common problems that may occur because each NIS server is administered differently at the sole discretion of the system administrator in charge of a particular NIS server include:

1) If the system administrator forgets to remove the name and access rights to a NIS server of an employee who no longer works for the company, then that ex-employee can continue to have access to the NIS server which may lead to a breach in security. This scenario is illustrated in FIG. 1, where at step 100, a system administrator forgets to remove terminated employee's name and access rights to a NIS server. At step 110, ex-employee logs in the NIS server. At step 120, ex-employee accesses data illegally.

2) All NIS servers are accessible by a username, which in many cases is predetermined by the company. This username may be the social security number of the employee, or some similar numerical form. If an incorrect username is assigned to an employee, or the employee knows the username of some other employee, then access to sensitive data may be given to the wrong person. This scenario is illustrated in FIG. 2, where at step 200, a user logs in a NIS server using a username. At step 210, if this username belongs to another user, or the user uses the username of another employee, then at step 220 user can access data not meant for him/her.

In other cases, since the system administrator can deny access to any employee within his/her jurisdiction, a mistake in the username may lead to denial of access to a legitimate employee. This scenario is illustrated in FIG. 3, where at step 300, a system administrator denies access to a NIS server to a valid employee. At step 310, valid user logs in the NIS server. At step 320, valid user denied access to data.

Furthermore, there is no process available today to ensure that the data entry in the username field is compliant with the standards of the company. For example, a company may predetermine that the user id (UD) be equal to their employee id plus 1000. If a person wants to illegally access the files on the NIS server of a company, and knows of this predetermined UID rule, then he/she can come up with a valid username in a few tries. This scenario is illustrated in FIG. 4, where at step 400, an illegal user plugs in a user id based on a predetermined user id rule of a company. At step 410, the NIS server checks to see if this number is a valid user id. If it is not, then the NIS server displays an error message to the user at step 420, who has the opportunity to plug in another number for the user id. If the number at step 410 is determined by the NIS server to be a valid user id, then at step 430 the user has illegal access to data.

3) The entry of an employee along with all his/her records can be removed accidentally before their status has officially been changed from “active employee” to “terminated employee”. This can create, for example, critical email to bounce back to the sender. This scenario is illustrated in FIG. 5, where at step 500, a system administrator changes the status of a user. At step 510, user has not officially changed status before the system administrator changes his/her status at step 500. At step 520, user logs in the NIS server. At step 530, user cannot access data because his/her status has been manually changed by the system administrator at step 500.

4) Some companies require their new and non-regular employees to complete a separate access questionnaire prior to be given an UNIX account. The present scenario has no process to ensure that non-regular or new employees have completed the separate access questionnaire prior to accessing the NIS server, and that could constitute a breach in security.

### SUMMARY OF THE INVENTION

The present invention provides a method for an account management module database interface for servers. According to one embodiment of the present invention, the server is a Naming Information System (NIS) server. According to another embodiment, the present invention automatically generates key files used to build NIS database manager maps which control the access to systems on a local area network. These systems may be UNIX systems. This embodiment helps when a company wants to enforce a “login anywhere” policy, where its employees can access current data using any server within the company's domain.

According to another embodiment of the present invention, the account management module database interface is divided into two components, viz.: the bulkload and the data pull. Both components access a relational database to both update and pull data used in the generation of the data. According to another embodiment of the present invention, the bulkload part is able to read a password, group and auto_home files, validate a record's contents, and update a database with information which meets a validation criteria. According to another embodiment of the present invention, the data pull component can pull out the necessary data from the database so that files required to build passwords, shadows, groups, auto_homes, and aliases map can be generated.

### BRIEF DESCRIPTION OF THE DRAWINGS

These and other features, aspects and advantages of the present invention will become better understood with regard to the following description, appended claims and accompanying drawings where:

FIG. 1 is a flowchart illustrating a problem with present NIS servers.

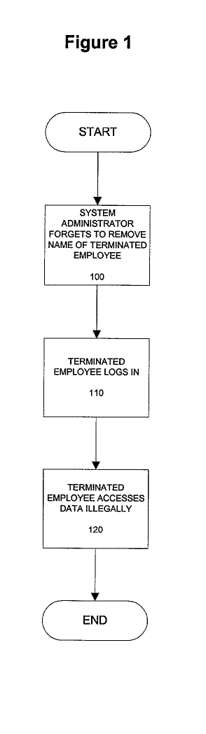

FIG. 2 is a flowchart illustrating another problem with present NIS servers.

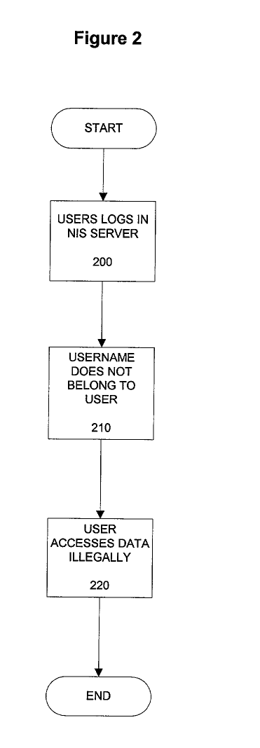

FIG. 3 is a flowchart illustrating another problem with present NIS servers.

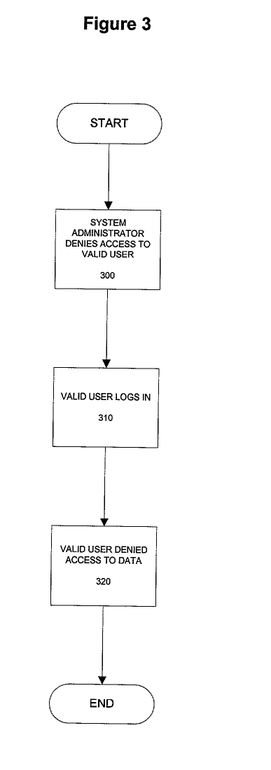

FIG. 4 is a flowchart illustrating another problem with present NIS servers.

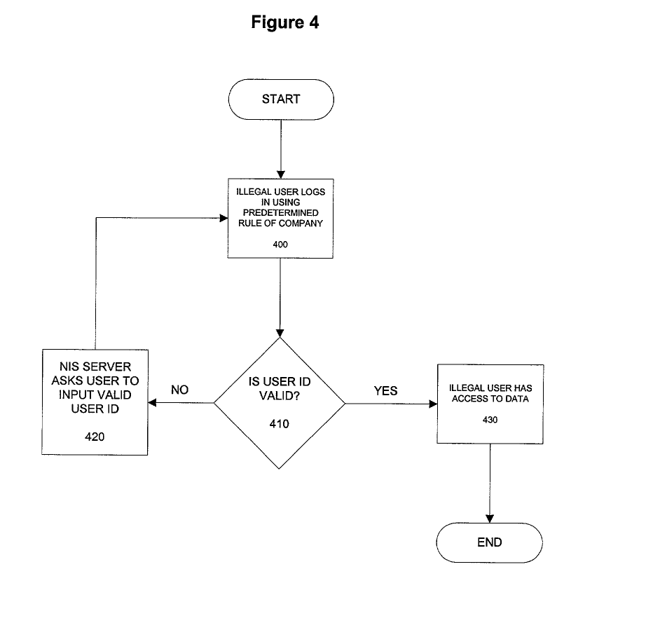

FIG. 5 is a flowchart illustrating another problem with present NIS servers.

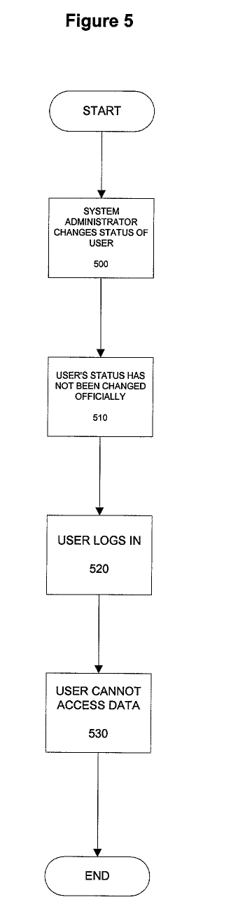

FIG. 6 is a flowchart illustrating the creation of an AMM.

FIG. 7 is a flowchart illustrating the pre-installation requirements of an AMM.

FIG. 8 is a flowchart illustrating the installation requirements of an AMM.

FIG. 9 is a flowchart illustrating the account management module database interface called bulkload.

FIG. 10 is a flowchart illustrating rejected entries when bulkload is run.

FIG. 11 is a flowchart illustrating the division of user logins.

FIG. 12 is an illustration of an embodiment of a computer execution environment.

FIG. 13 is a block diagram illustrating the pulling of information and rebuilding of components.

FIG. 14 is one embodiment of the one time bulkload.

FIG. 15 is one embodiment of the test pull operation.

### DETAILED DESCRIPTION OF THE INVENTION

The invention provides a method and apparatus for an account management module database interface for servers. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Account Management Module

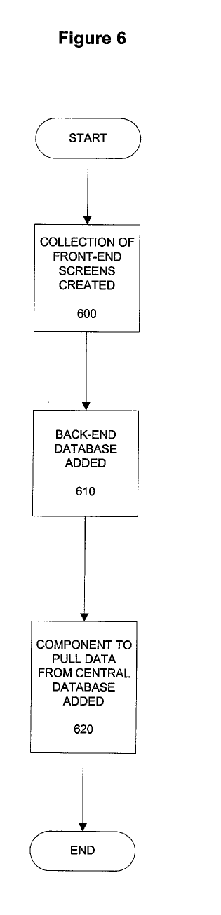

According to one embodiment of the present invention, the account management module, also called the NetAdmin Account Management Module (AMM), is a framework that helps centralize the administration of all employees and network information throughout a company. It consists of a collection of front-end screens to create and maintain resources such as user, group, and aliases maintenance, a back-end database, and a component that is installed by subscribing masters that pull information periodically from this central database. In one embodiment, the database is a Sybase database. In another embodiment the master is a NIS master. The creation of an AMM according to one embodiment of the present invention is seen in FIG. 6. At step 600, a collection of front-end screens are created. At step 610, a back-end database is attached. At step 620, a component to pull data from a central database is attached.

In one embodiment, there are five main components of NIS information that the AMM interacts with. In one embodiment the components include password, shadow, group, auto_home, and aliases. These five components are created and maintained via front-end graphical user interface screens at a central location, for example netadmin.central. The AMM enables the NIS accounts to be managed through NetAdmin in the same way that email addresses and mailing lists are managed by way of enforcing standards, controlling access, changing history, and reducing IT costs.

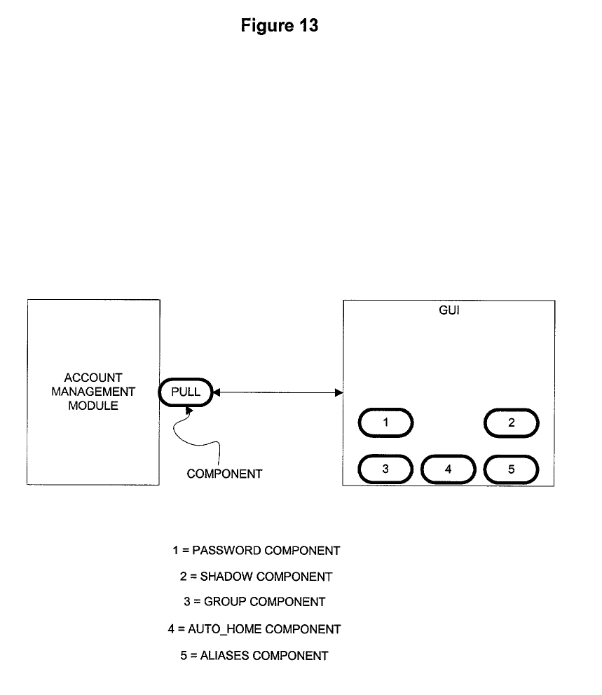

The local NIS masters periodically “pull” the information and rebuild the NIS maps password, shadow, group, auto_home, and aliases, and hence the latest information regarding any employee is served to other employees and applications. The pulling of information and rebuilding of components, according to one embodiment of the present invention, is illustrated in FIG. 13. AMM is divided into two parts that handle the updating and pulling of data used in the generation of the NIS data. These two parts are the bulkload and the data pull. Before discussing these two parts, it is intuitive to discuss the installation of the AMM along with pre and post installation requirements and tests.

AMM Pre-Installation

According to one embodiment of the present invention, before the AMM is installed on any NIS server, the following need to be known or available to the NIS master server, and include:

a) A fully operational NIS Master server.

b) The NIS Master server must have a predetermined amount of free space in the /tmp file system.

c) Root access is needed to the NIS Master server.

d) The domain of the NIS Master server has to be known.

e) Things to check before and/or after the NetAdmin accounts are converted, include: since the NetAdmin accounts remove the current visitor logins from the NIS password, shadow, and auto_home files during the upload process, if the visitor has a complete record in NetAdmin then they will be added back into the NIS maps with the exception that auto_home will now point to their home server across the WAN. Furthermore, their login may change to company.net. This means that the visitor's additional home on the server being converted is left orphaned and unnecessarily takes up valuable space. Unless one is familiar with the site, it is time consuming to find and remove these redundant homes.

f) All pre-Solaris 8 servers must have Java 1.2 or greater along with JRE 1.2 or greater installed.

g) All locations of users on the NIS server being converted have to be known, which is needed for the bulkload operation.

h) A full backup of all password, shadow, group, auto_home, and aliases files need to be made to a safe location.

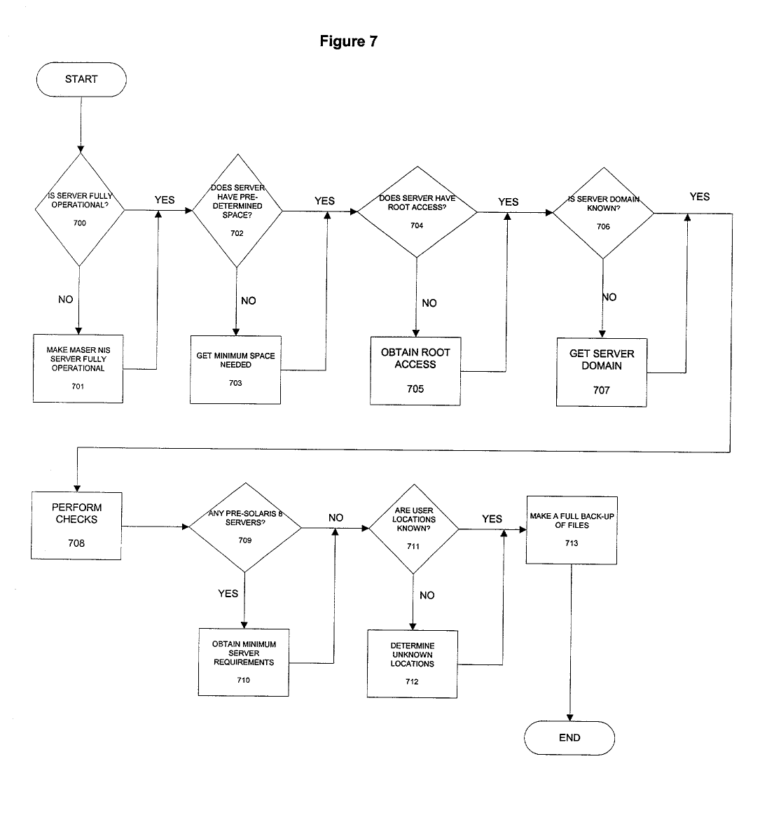

The pre-installation requirements mentioned above are illustrated in FIG. 7. At step 700 the check to see if the master NIS server is fully operational is made. If the master NIS server is not fully operational, then at step 701 the master NIS server is made fully operational. On the other hand, if the master NIS server is fully operational, then at step 702 the check to see if the master NIS server has enough free space is made. If the master NIS server does not have the minimum space needed, then at step 703 the minimum space is got. On the other hand, if enough free space is available, then at step 704 the check to see if the master NIS server has root access is made. If the master NIS server does not have root access, then at step 705 root access is made available to the master NIS server. On the other hand, if root access is available, then at step 706 the check is made to see if the domain of the master NIS server is known.

If the domain is not known, then at step 707 the domain name of the master NIS server is determined. On the other hand, if the domain is known, then at step 708 checks are performed before and/or after NetAdmin accounts are converted. At step 709, the checks is to see if any pre-Solaris 8 servers are present and they all have Java 1.2 or greater version along with JRE 1.2 or greater version are made. If any pre-Solaris 8 servers do not have the required Java version, then the minimum Java version is first installed on those servers at step 710. On the other hand, if the all servers have the minimum Java version, then at step 711 the check to see if all locations of users on the server are known prior to the conversion is made. If any locations are not know, then at step 712 those locations are determined. On the other hand, is all user locations are known, then at step 713 a full backup of files are made and saved in a safe location.

AMM Installation

According to one embodiment of the present invention, the following are the steps required to install the AMM on a NIS server, and includes:

1) Logging in the target server (NIS Master server) as the “root” user.

2) Transferring to the /tmp directory to download the AMM.

3) Downloading the AMM using a file transfer protocol (FTP) from a predetermined site.

4) Uncompressing any tar files.

5) Running an utility, for example the pkgadd utility, to install the NetAdmin AMM software.

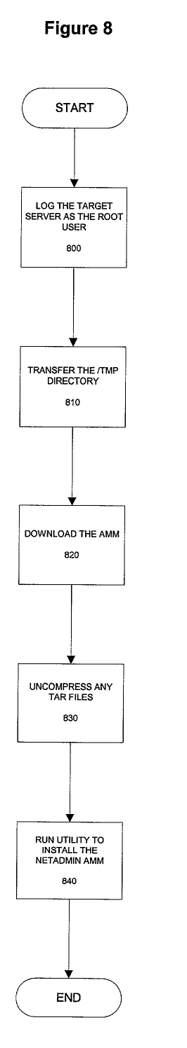

The installation steps are illustrated in FIG. 8, where at step 800, the target server is logged in as the “root” user. At step 810, the /tmp directory is transferred. This is needed to download the AMM. At step 820, the AMM is downloaded using a file transfer protocol from a predetermined site. At step 830, all tar files downloaded are uncompressed. Any of the commercially available uncompression programs, for example WinZip, can be used to uncompress the files. At step 840, the NetAdmin AMM software is installed using a utility, for example, the pkgadd utility.

AMM Post-Installation

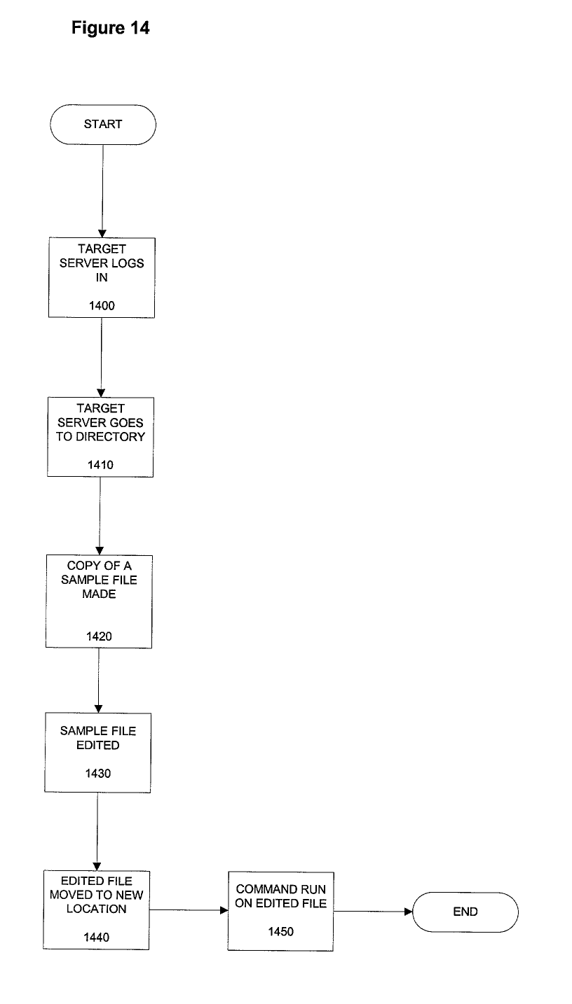

According to one embodiment of the present invention, in order to configure the NetAdmin AMM software downloaded, a one time bulkload operation (explained in detail below) is performed followed by a test pull operation (explained in detail below), and the configuration of the root's “crontab” to pull data periodically. To perform the bulkload operation the Java file amm.jar is run with the source files as the argument. At this point, the locations of all the users serviced by this particular NIS Master has to be known in order to pass the information as arguments to the script. One embodiment of the one time bulkload is illustrated in FIG. 14, and may look like:

a) At step 1400, the target server logs as a root user.

b) At step 1410, the target server goes to a directory. For example: /opt/ITPSaccmg/bin.

c) At step 1420, a copy of a sample amm.properties_bulkload file is made from the does directory to this directory.

d) At step 1430, the sample amm.properties_bulkload file is edited as needed.

e) At step 1440, the edited sample amm.properties bulkload file is moved to amm.properties.

f) At step 1450, a amm.jar command is run on the bulkload file. For example:

#/usr/j2rel_{—}3_{—}0/bin/java-jar/opt/ITPSaccmg/amm.jar.

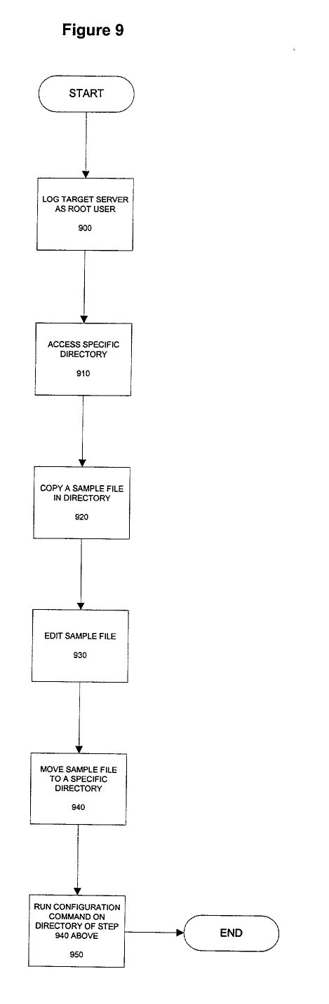

An illustration of a bulkload, according to one embodiment of the present invention, is shown in FIG. 9, where at step 900, the target server is logged in as a root user. At step 910, a specific directory, for example, the /opt/ITPSaccmg/bin directory is accessed. At step 920, a sample file, for example, the amm.properties_bulkload file is copied to the directory of step 910. At step 930, the sample file of step 920 is edited as needed. At step 940, the edited file of step 930 is moved to a directory, for example, the amm.properties directory. At step 950, a configuration command, for example, the amm.jar command is run on the directory of step 940.

According to one embodiment of the present invention, all rejected entries are written to files ending with a_reject suffix, and include auto_home_reject, password_reject, shadow reject, and group reject files. These files are only created if there are rejected entries during bulkload, and each rejected entry will include the reasons for the rejection. If the bulkload aborts due to any errors, for example, if the database goes down in the middle of an upload, the user performing the upload has to add a “-reset” option to the bulkload process the next time around. If on the other hand, the bulkload runs successfully without any errors, but there are rejected entries, the following may be performed to fix the rejections:

a) Fix the rejections based on the reasons for their reject.

b) If the fixed entries are small in number, they can be entered directly into the NetAdmin database via the GUI front-end screens.

c) If the fixed entries are large in number, then:

i) Enable a new bulkload by clicking on the reset flag in the NIS domain maintenance screen. This preserves all entries that were successfully entered into the database via the previous bulkload operation.

ii) Run the bulkload operation again with just the fixed entries.

iii) Any changes that need to be made to the already successful loaded entries can also be made in the new source file(s), and the bulkload operation will synchronize the modified values in the database.

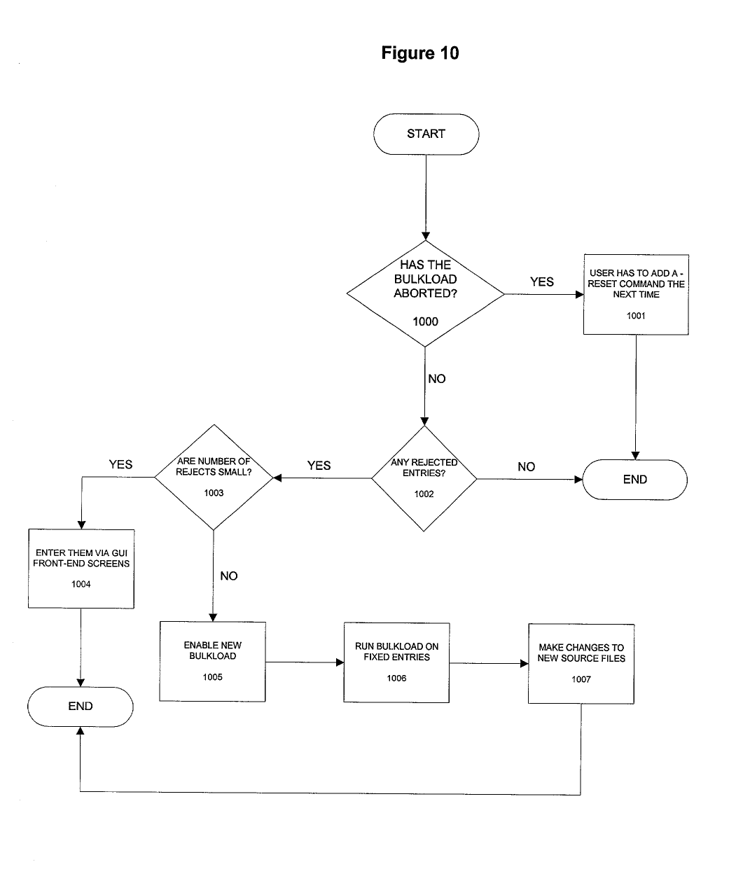

Handling of rejected entries (if any) is illustrated in FIG. 10. At step 1000, the check to see if the bulkload has aborted is made. If it has, then at step 1001 the user has to add a ‘-reset’ command to configure the software using bulkload. One the other hand, is the bulkload runs successfully, then the check to see if there any rejected entries is made at step 1002. If there are rejected entries, then at step 1004 the check to see if the number of entries are small is made. If the number of entries are small, then at step 1005 the rejected entries are fixed via the GUI front-end screens. If not (if the number of rejected entries is large), then at step 1006 a new bulkload is enabled. At step 1007, the new bulkload is run on the fixed entries only. At step 1008, the changes are made to the new source files.

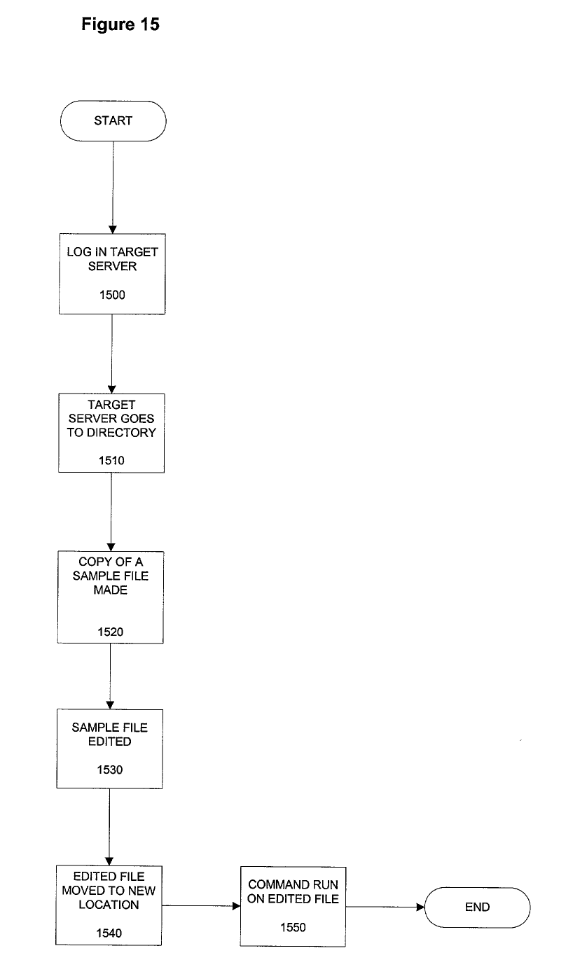

To run a test pull operation, the source for the password, shadow, group, aliases, and auto_home maps are pulled from the NetAdmin. After this the NIS maps are regenerated by running amm from the NIS Master. One embodiment of the test pull operation is illustrated in FIG. 15, and may look like:

a) At step 1500, user logs into the target server as a root user.

b) At step 1510, the user goes to a directory. For example: /opt/ITPSaccmg/bin.

c) At step 1520, a copy of one of the sample pull files (for example, amm.properties_mailhost, amm.properties_nis, or amm.properties_combined) is made from the docs directory to this directory.

d) At step 1530, the sample resource pull file is edited as needed.

e) At step 1540, the edited sample resource file is moved to amm.properties.

f) At step 1550, the amm.jar command is run on the pull file. For example:

#/usr/j2rel_{—}3_{—}0/bin/java-jar/opt/ITPSaccmg/amm.jar.

As a safety backup, the log files created in /var/netadmin/log after each amm.jar run are checked, and all the entries matched to the original source files to resolve any problems.

To configure the root's “crontab” to pull periodically, several entries need to be added using the crontab-e command. An example configuration of the root's crontab may look like:

#

# NetAdmin Accounts

#

05 7,13,19 * * * /usr/j2rel_{—}3_{—}0/bin/java-jar/ opt/ITPSaccmg/bin/amm.jar/tmp/;

#

# NetAdmin Accounts cleanup

13 1 * * * find /etc/nis-name “aliases_*”-mtime +3-exec /usr/bin/rm ‘{ }’>/

13 1 * * * find /etc/nis -name “auto_home_*”-mtime +3-exec /usr/bin/rm ‘{ }’

14 1 * * * find /etc/nis -name “group_*”-mtime +3-exec /usr/bin/rm ‘{ }’>/

14 1 * * * find /etc/nis\(-name “password_*” -o-name “shadow_*”\)-mtime +3

15 1 *** find /var/netadmin/log-name “amm_*”-mtime +3-exec /usr/bin/rm ‘{ }’

In domains that have multiple NIS Masters, the periodic pulls within crontab may be varied to optimize the pull operation.

Next, the two parts of the AMM, viz.: the bulkload and the data pull, that handle the updating and pulling of data used in the generation of the NIS data are described.

Bulkload: Password File Entries

According to one embodiment of the present invention, the AMM loads into the NetAdmin database the information of any record, once per NIS domain. The information, which meets certain criteria, includes:

a) The user identity (UID) of the employee equals the one given by the company, and/or matches other valid parameters or criteria;

b) The login name in the password file matches the login name for the NetAdmin; and

c) At least one word of the GCOS (?) field matches one of a list of parameters, which include: the first or last name in the Human Resources (HR) database, or the NetAdmin Preferred first or last name. This means that employees with empty GCOS fields are not bulk loaded in NetAdmin, which is a safety measure to ensure that the wrong person's data is not updated. The AMM also has the capability to load as a “system” entry the information of any UID that does not meet any/some of the criteria mentioned above. Since the AMM and NetAdmin support the notion of “global system entries”, a global entry would have the same UID and group identity (GID) in every NIS domain. The AMM and NetAdmin also supports the notion of “global groups”, in which case the global group will have the same group number and members in every NIS domain.

Bulkload: Groups and Group Members

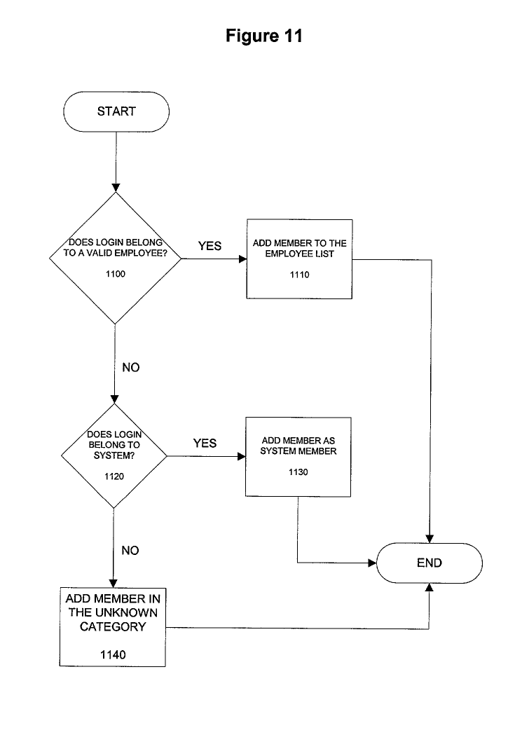

According to one embodiment of the present invention, group members are maintained in three main category, viz. employees, system, and unknown. During the bulkload process each member is evaluated to see if it is a login belonging to a valid employee. This evaluation is illustrated in FIG. 11 at step 1100. If the login is of a valid employee, then at step 1110 the member is added as an employee. If not, then at step 1120 the member is evaluated to see if it is a system login. If the login belongs to a system, then at step 1130 the member is added as a system member. If the member does not evaluate to either of the two categories mentioned above, the member is added to the unknown category at step 1140. Most members in the unknown category are ex-employees whose logins were never removed from the group file. The NIS screen then has a way to either delete these members permanently, or reinstate them as system members.

Some general characteristics of the bulkload are mentioned next.

Bulkload: Auto_Home Format

The AMM only extracts the first server mentioned in the auto_home i file for each user, which is the server used to set the user's Home Directory Server in NetAdmin.

Bulkload: Long Logins

Logins longer than 8 characters long are truncated to 8 characters, and the name is then checked for uniqueness.

Bulkload: Diagnostics

The AMM prints a diagnostic message prior to any early exits. During normal processing some of the types of messages printed to standard output (computer screen) include:

a) Lines that start with “ERR” indicate the data was acceptable, but a Sybase error occurred while trying to update the database. This usually happens when the database goes down in the middle of a bulkload.

b) Lines that start with “REJ” indicate an unacceptable record. Subsequent information is then provided to indicate the exact problem.

c) Lines that start with “CREATED” indicate that a NIS group was created.

d) Lines that start with “ADDED” indicate that a member was added to a NIS group.

e) Lines that start with “CHANGED” indicate that an information was changed for a certain member.

Data Pull: Requirements

According to one embodiment of the present invention, for the NIS domain registration to use the AMM for the bulkload and subsequent data pull operations, the NIS domain has to register in NetAdmin using the Network Resources→NIS screen. Furthermore, since NetAdmin does not have the GCOS (?), home directory server, and home directory for most employees, it is required that the bulk load program is run for each NIS domain before the records for that domain are pulled, or in the case of brand new NIS domains at least one correct entry in NetAdmin is needed to be assigned to the NIS domain.

To be included in the generated files or NIS maps, an employee has to have an active status according to the HR database, or the NetAdmin status has to be in the “enable” mode. In addition, if the particular employee is a temporary employee, contractor, or partner, NetAdmin has to have knowledge that the employee has met with all the criteria mentioned in the bulkload: password file entries above. Furthermore, the information in the NetAdmin include the employee UID as well as login.

Data Pull: Local Files and Lock File

According to one embodiment of the present invention, the AMM is able to catenate to each of the generated files during the data pull process a “local” file which may have information to override NetAdmin, or which is not yet in NetAdmin. During a data pull process, the AMM creates a lock file called, for example, /tmp/amm_lock when it starts moving the target files after having completed pulling new files. The presence of this file indicates that since the NIS files are still being updated, the “make” command should not be executed. The lock file is automatically deleted once all the target files have been moved into place.

Login Anywhere

As mentioned earlier, the automatic generation of key files used to build the NIS database manager maps which control the access to UNIX systems on a local area network helps in imposing the “login anywhere” policy of some companies. If the login of an employee is not unique across all NIS domains within the company, an algorithm is used to determine what login to provide to each employee so that every employee is able to access the NIS server from anywhere within the domain of the company. This algorithm may look like:

If the employee's UNIX login, which is indicated in the NetAdmin employee information→User Administration screen, is unique across all NIS domains, then the UNIX login is used in all NIS domains. If on the other hand, the employee's UNIX login is not unique across all NIS domains, then some other predetermined login is used in all NIS domains except the employee's primary NIS domain. This primary NIS domain will continue to use the UNIX login to avoid conflicts in Mail and browsers like Netscape.

Embodiment of a Computer Execution Environment

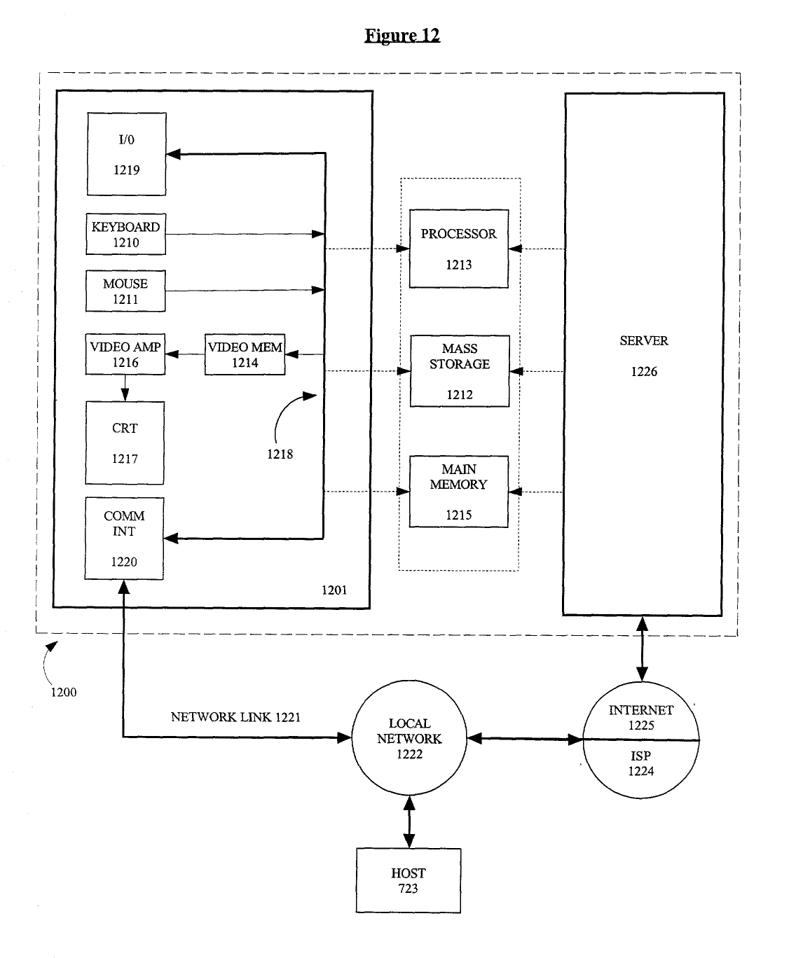

An embodiment of the invention can be implemented as computer software in the form of computer readable code executed in a desktop general purpose computing environment such as environment 1200 illustrated in FIG. 12, or in the form of bytecode class files running in such an environment. A keyboard 1210 and mouse 1211 are coupled to a bi-directional system bus 1218. The keyboard and mouse are for introducing user input to a computer 1201 and communicating that user input to processor 1213.

Computer 1201 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals, which carry digital data streams representing various types of information.

Network link 1221 typically provides data communication through one or more networks to other data devices. For example, network link 1221 may provide a connection through local network 1222 to local server computer 1223 or to data equipment operated by ISP 1224. ISP 1224 in turn provides data communication services through the world wide packet data communication network now commonly referred to as the “Internet” 1225. Local network 1222 and Internet 1225 both use electrical, electromagnetic or optical signals, which carry digital data streams. The signals through the various networks and the signals on network link 1221 and through communication interface 1220, which carry the digital data to and from computer 1200, are exemplary forms of carrier waves transporting the information.

Processor 1213 may reside wholly on client computer 1201 or wholly on server 1226 or processor 1213 may have its computational power distributed between computer 1201 and server 1226. In the case where processor 1213 resides wholly on server 1226, the results of the computations performed by processor 1213 are transmitted to computer 1201 via Internet 1225, Internet Service Provider (ISP) 1224, local network 1222 and communication interface 1220. In this way, computer 1201 is able to display the results of the computation to a user in the form of output. Other suitable input devices may be used in addition to, or in place of, the mouse 1211 and keyboard 1210. I/O (input/output) unit 1219 coupled to bi-directional system bus 1218 represents such I/O elements as a printer, A/V (audio/video) I/O, etc.

Computer 1201 includes a video memory 1214, main memory 1215 and mass storage 1212, all coupled to bidirectional system bus 1218 along with keyboard 1210, mouse 1211 and processor 1213.

As with processor 1213, in various computing environments, main memory 1215 and mass storage 1212, can reside wholly on server 1226 or computer 1201, or they may be distributed between the two. Examples of systems where processor 1213, main memory 1215, and mass storage 1212 are distributed between computer 1201 and server 1226 include the thin-client computing architecture developed by Sun Microsystems, Inc., the palm pilot computing device, Internet ready cellular phones, and other Internet computing devices.

The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as processor 1213, main memory 1215, video memory 1214, and mass storage 1212. Alternatively, multiplex data/address lines may be used instead of separate data and address lines.

In one embodiment of the invention, the processor 1213 is a microprocessor manufactured by Motorola, such as the 680×0 processor or a microprocessor manufactured by Intel, such as the 80×86 or Pentium processor, or a SPARC microprocessor from Sun Microsystems, Inc. However, any other suitable microprocessor or microcomputer may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1201 can send messages and receive data, including program code, through the network(s), network link 1221, and communication interface 1220. In the Internet example, remote server computer 1226 might transmit a requested code for an application program through Internet 1225, ISP 1224, local network 1222 and communication interface 1220. The received code may be executed by processor 1213 as it is received, and/or stored in mass storage 1212, or other non-volatile storage for later execution. In this manner, computer 1200 may obtain application code in the form of a carrier wave. Alternatively, remote server computer 1226 may execute applications using processor 1213, and utilize mass storage 1212, and/or video memory 1215. The results of the execution at server 1226 are then transmitted through Internet 1225, ISP 1224, local network 1222, and communication interface 1220. In this example, computer 1201 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method for an account management module database interface for servers is described in conjunction with one or more specific embodiments. The invention is defined by the following claims and their full scope of equivalents.

We claim:

1. A method for providing a database interface comprising: generating one or more key files to build a database manager map; using said database manager map to control access to a database; and modifying said database, if necessary, using a first interface.

2. The method of claim 1 wherein said database manager map controls access to a server on a local area network.

3. The method of claim 2 wherein said server is a UNIX system.

4. The method of claim 1 wherein said first interface comprises a bulkload and a data pull.

5. The method of claim 4 wherein said bulkload and said data pull can both access said database to both update and pull data used in the generation of said data.

6. The method of claim 4 wherein said bulkload is able to read a password, a group and an auto_home file, validate a record's contents, and update said database with information.

7. The method of claim 4 wherein said data pull can pull out a necessary data therein from said database so that one or more files required to build a password, a shadow, a group, an auto_home, and an aliases map can be generated.

8. An article of manufacture comprising:
one or more key files configured to be generated to build a database manager map;
a database whose access is controlled using said database manager map; and
a first interface configured to be used to modify said database, if necessary.

9. The article of manufacture of claim 8 wherein said database manager map controls access to a server on a local area network.

10. The article of manufacture of claim 9 wherein said server is a UNIX system.

11. The article of manufacture of claim 8 wherein said first interface comprises a bulkload and a data pull.

12. The article of manufacture of claim 11 wherein said bulkload and said data pull can both access said database to both update and pull data used in the generation of said data.

13. The article of manufacture of claim 11 wherein said bulkload is able to read a password, a group and an auto_home file, validate a record's contents, and update said database with information.

14. The article of manufacture of claim 11 wherein said data pull can pull out a necessary data therein from said database so that one or more files required to build a password, a shadow, a group, an auto_home, and an aliases maps can be generated.

15. A computer program product comprising:
a computer useable medium having computer readable program code embodied therein configured for providing a database interface, said computer program product comprising:
computer readable code configured therein to cause a computer to generate one or more key files to build a database manager map;
computer readable code configured therein to cause a computer to use said database manager map to control access to a database; and
computer readable code configured therein to cause a computer to modify said database, if necessary, using a first interface.

16. The computer program product of claim 15 wherein said database manager map controls access to a server on a local area network.

17. The computer program product of claim 16 wherein said server is a UNIX system.

18. The computer program product of claim 15 wherein said first interface comprises a bulkload and a data pull.

19. The computer program product of claim 18 wherein said bulkload and said data pull can both access said database to both update and pull data used in the generation of the data.

20. The computer program product of claim 18 wherein said bulkload is able to read a password, a group and an auto_home file, validate a record's contents, and update said database with information.

21. The computer program product of claim 18 wherein said data pull can pull out a necessary data therein from said database so that files required to build a password, a shadow, a group, an auto_home, and an aliases maps can be generated.
